(19) United States
(12) Patent Application Publication
(10) Pub. No.: US 2026/0316682 A1
(43) Pub. Date: Oct. 15, 2026

(54) DIGITAL REAR MIRROR DEVICE AND SYSTEM, AND METHOD OF OPERATING SAME

(71) Applicant: THINKWARE CORPORATION, Seongnam-si (KR)

(72) Inventors: Hyun Chul CHO, Seongnam-si (KR); Hyun Jin BANG, Seongnam-si (KR); Sung Rak CHOI, Seongnam-si (KR)

(21) Appl. No.: 19/462,062

(22) Filed: Jan. 28, 2026

Related U.S. Application Data
(63) Continuation of application No. PCT/KR2024/010935, filed on Jul. 26, 2024.

(30) Foreign Application Priority Data
Jul. 31, 2023 (KR) 10-2023-0099943
Jul. 18, 2024 (KR) 10-2024-0095201

(51) Int. Cl. B60R 1/28; H04N 23/62; H04N 23/69

(52) U.S. Cl. CPC B60R 1/28; H04N 23/62; H04N 23/69

(57) ABSTRACT

The present disclosure provides a digital rear mirror device, a digital rear mirror system, and a method for operating same. In the present disclosure, the digital rear mirror system comprises: a camera device mounted on a vehicle and configured to capture a rear image of the vehicle; and a digital rear mirror device configured to display a field-of-view image detected from the rear image. Either the camera device or the digital rear mirror device may detect the field-of-view image from the rear image. Either the camera device or the digital rear mirror device may set a position where the field-of-view image is to be detected in the rear image on the basis of a user input via the digital rear mirror device.

### CROSS-REFERENCE TO RELATED APPLICATIONS

This U.S. non-provisional application is a continuation application of PCT International Application PCT/KR2024/010935, which has an international filing date of Jul. 26, 2024, and claims priorities under 35 U.S.C. 119 to Korean Patent Application No. 10-2023-0099943, filed on Jul. 31, 2023 and Korean Patent Application No. 10-2024-0095201, filed on Jul. 18, 2024, in the Korean intellectual property office, the disclosures of which are herein incorporated by reference in its entirety.

### BACKGROUND

### Technical Field

The present disclosure relates to a digital rear mirror (DRM) device and system, and a method of operating the same.

### Related Art

A driver who drives a vehicle must keep an eye on the front while also keeping an eye on the rear while driving. To this end, the vehicle is equipped with a rear mirror (which may also be referred to as one of a rear-view mirror, a back mirror, a room mirror, or an inside mirror). That is, the driver checks the rear through the rear mirror while maintaining a forward posture. However, due to passengers, objects, or cargo behind the driver, or separate loading compartments with space provided for loading cargo, the driver's rear view is often obscured in the rear mirror. This can lead to various risks.

### SUMMARY

The present disclosure provides a digital rear mirror device and system that provides a rear view of a vehicle, and a method of operating the same.

In the present disclosure, a digital rear mirror system of a vehicle may include a camera device configured to capture a rear image of the vehicle, and a digital rear mirror device configured to display a field of view image detected from the rear image.

In the present disclosure, a method of operating a digital rear mirror system of a vehicle may include: capturing a rear image of the vehicle by a camera device; and displaying, by a digital rear mirror device, a field of view image detected from the rear image.

In the present disclosure, a camera device connected to a digital rear mirror device in a vehicle may include: an interface module communicatively connected to the digital rear mirror device; a camera module configured to capture a rear image of the vehicle; and an interface module connected to the interface module and the camera module, and configured to detect a field of view image from the rear image, and transmit the field of view image to a digital rear mirror device to cause the digital rear mirror device to display the field of view image.

In the present disclosure, a method of operating a camera device connected to a digital rear mirror device in a vehicle may include: capturing a rear image of the vehicle; detecting a field of view image from the rear image; and transmitting the field of view image to the digital rear mirror device to cause the digital rear mirror device to display the field of view image.

In the present disclosure, a digital rear mirror device of a vehicle may include: a display module having a display area; an interface module communicatively connected to a camera device for capturing a rear image of the vehicle; and a processor connected to the display module and the interface module and configured to display a field of view image detected from the rear image in the display area.

In the present disclosure, a method of operating a digital rear mirror device of a vehicle may include: confirming a field of view image detected from a rear image of the vehicle captured by a camera device; and displaying the field of view image in a display area.

According to the present disclosure, the digital rear mirror device displays a field of view image detected from a rear image of the vehicle captured by a camera device, thereby providing an unobstructed rear field of view to a driver of the vehicle. According to a first embodiment, when the camera device detects a field of view image from the rear image, the field of view image is transmitted from the camera device to the digital rear mirror device, so that a transmission load between the digital rear mirror device and the camera device may be reduced. This can lead to rational component selection in implementing a digital rear mirror system, improved transmission noise between the digital rear mirror device and the camera device, and increased transmission power efficiency. According to a second embodiment, when the digital rear mirror device detects the field of view image from the rear image, the camera device transmits the rear image to the digital rear mirror device, so that a general camera device may be used without change. In addition, according to the present disclosure, since a position of the field of view image detected in the rear image may be adjusted based on a user input, the rear field of view may be provided to the driver at a viewing angle desired by the driver. At this time, the driver may present a user input while checking a change in the viewing angle in real time through the digital rear mirror device, so that the desired viewing angle may be intuitively determined. This can lead to improved user convenience and stability in utilizing the digital rear mirror system.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of a digital rear mirror system according to various embodiments;

FIG. 2 is an exemplary diagram for explaining a first function of the digital rear mirror system of FIG. 1;

FIG. 3 is an exemplary diagram for explaining a second function of the digital rear mirror system of FIG. 1;

FIG. 4A is a flowchart illustrating a display method of the digital rear mirror system according to a first embodiment;

FIG. 4B is a flowchart illustrating another display method of the digital rear mirror system 100 according to the first embodiment;

FIG. 5 is a flowchart illustrating a setting method of the digital rear mirror system according to the first embodiment;

FIG. 6 is a flowchart illustrating another setting method of the digital rear mirror system according to the first embodiment;

FIG. 7A is a flowchart illustrating a display method of a digital rear mirror system according to a second embodiment;

FIG. 7B is a flowchart illustrating another display method of the digital rear mirror system according to the second embodiment;

FIG. 8 is a flowchart illustrating a method of setting a digital rear mirror system according to the second embodiment;

FIG. 9 is a block diagram illustrating an internal configuration of a camera device according to various embodiments;

FIG. 10 is a flowchart illustrating a method of operating a camera device according to a first embodiment;

FIG. 11 is a flowchart illustrating a method of operating a camera device according to the second embodiment;

FIG. 12 is a block diagram illustrating an internal configuration of a digital rear mirror device according to various embodiments;

FIG. 13 is a flowchart illustrating a method of operating a digital rear mirror device according to a first embodiment;

FIG. 14 is a flowchart illustrating a method of operating a digital rear mirror device according to the second embodiment;

FIG. 15 is a block diagram illustrating a vehicle equipped with a digital rear mirror system according to various embodiments; and

FIG. 16 is a block diagram illustrating a control device of the vehicle of FIG. 15.

### DETAILED DESCRIPTION

Hereinafter, various embodiments of the present document are described with reference to the accompanying drawings.

First, a digital rear mirror system 100 according to various embodiments is described.

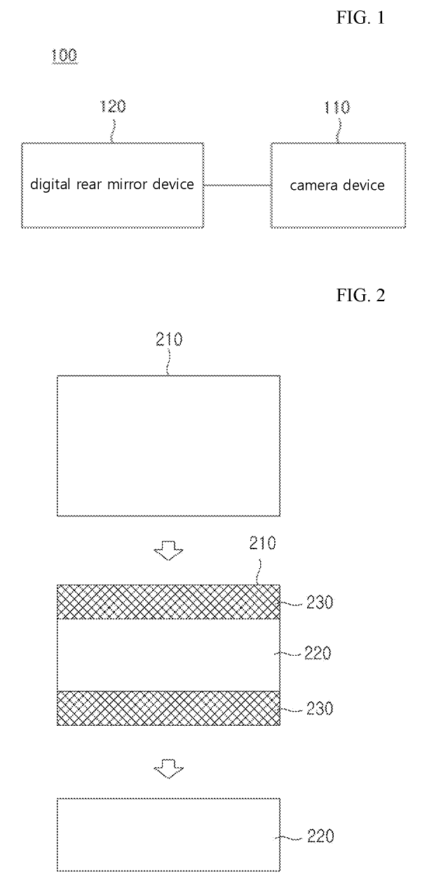

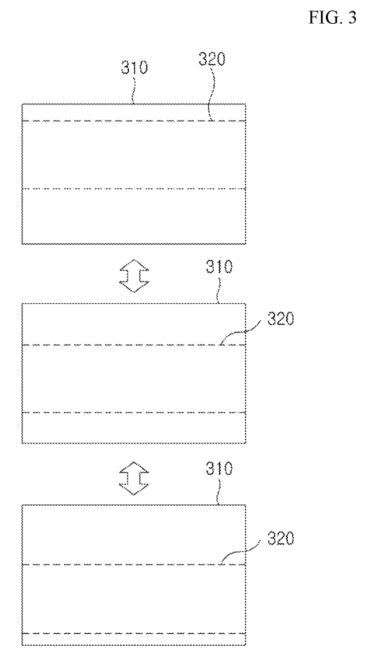

FIG. 1 is a block diagram illustrating a configuration of a digital rear mirror system 100 according to various embodiments. FIG. 2 is an exemplary diagram illustrating a first function of the digital rear mirror system 100 of FIG. 1. FIG. 3 is an exemplary diagram illustrating a second function of the digital rear mirror system 100 of FIG. 1.

Referring to FIG. 1, the digital rear mirror system 100 may include a camera device 110 and a digital rear mirror device 120. The digital rear mirror system 100 is mounted inside a vehicle, and may be configured to obtain image information about a surrounding environment of the vehicle through the camera device 110, store the image information in a memory 930 in the camera device 110, or output visual information through the digital rear mirror device 120 based on the image information. In some embodiments, at least one other component (e.g., another camera device) may be added to the digital rear mirror system 100.

The camera device 110 and the digital rear mirror device 120 may be communicatively connected to each other in a wired or wireless manner. In an embodiment, the camera device 110 may be connected to the digital rear mirror device 120 through a communication cable. The camera device 110 may communicate with the digital rear mirror device 120 in a serial transmission manner. However, the present disclosure is not limited thereto, and the camera device 110 and the digital rear mirror device 120 may be connected to each other through intra-vehicle network communication (e.g., CAN communication). The camera device 110 and the digital rear mirror device 120 may include various communication chips.

The image captured by the camera device 110 may be an image of the surroundings of the vehicle. For example, the camera device 110 can obtain a rear image 210 of the vehicle. To this end, the camera device 110 may be mounted on the rear of the vehicle so as to face rearward of the vehicle.

The digital rear mirror device 120 may provide an image captured by the camera device 110 to be displayed. An image of the surroundings obtained by the camera device 110 may be displayed on the digital rear mirror device 120 mounted inside the vehicle. For example, an image of the rear of the vehicle obtained through the camera device 110 may be provided to the driver of the vehicle through the digital rear mirror device 120. To this end, the digital rear mirror device 120 may be disposed within the field of view of the driver.

Referring to FIG. 2, the digital rear mirror device 120 may be provided to display a field of view image 220 detected from the rear image 210. Specifically, the digital rear mirror device 120 may have a display area of a predetermined size and resolution, and may display the field of view image 220 in the display area.

According to various embodiments, the digital rear mirror system 100 may have a first function, that is, a crop function. That is, the digital rear mirror system 100 may detect the field of view image 220 as at least a portion of the rear image 210. The rear image 210 may have a resolution of the camera device 110, and the field of view image 220 may have a resolution of a display area of the digital rear mirror device 120. Accordingly, the field of view image 220 may be detected from the rear image 210 based on the resolution of the display area of the digital rear mirror device 120. For example, as shown in FIG. 2, as the resolution of the display area of the digital rear mirror device 120 is lower than the resolution of the camera device 110, the rear image 210 is divided into the field of view image 220 and the remaining image 230, and the field of view image 220 may be detected by removing the remaining image 230 from the rear image 210. According to a first embodiment, the camera device 110 may detect the field of view image 220 from the rear image 210. According to a second embodiment, the digital rear mirror device 120 may detect the field of view image 220 from the rear image 210. Accordingly, the digital rear mirror device 120 may display the field of view image 220 in the display area.

According to some embodiments, although not shown, the camera device 110 or the digital rear mirror device 120 may detect the field of view image 220 by setting at least one or more areas of interest from the rear image 210. Here, the area of interest may be an area including a lot of image information (e.g., objects). For example, the rear image 210 of the vehicle obtained through the camera device 110 may be corrected. Here, the image correction may generate an image having a size larger than that of the rear image 210. That is, a corrected image having a size greater than that of the rear image 210 may be generated, and a horizontal length of the corrected image may be longer than that of the rear image 210, but is not limited thereto. A vertical length of the corrected image may be longer than the vertical length of the rear image 210, but is not limited thereto. The horizontal length of the corrected image may be greater than the horizontal length of the rear image 210, and the vertical length of the corrected image may also be greater than that of the rear image 210. In the generated corrected image, only an area having a lot of information may be set as the area of interest, and only information of non-areas of interest may be cropped to detect only the area of interest as the field of view image 220.

According to various embodiments, the digital rear mirror system 100 may have a second function, that is, a tilt function. That is, the digital rear mirror system 100 may adjust the position of the field of view image 220 to be detected in the rear image 210. Each driver of the vehicle may have a desired field of view angle, which may vary depending on the situation. Therefore, the digital rear mirror system 100 may determine the position of the field of view image 220 to be detected in the rear image 210 according to the required field of view angle based on a user input. For example, as shown in FIG. 3, the position of the setting area 320 having a size corresponding to the resolution of the field of view image 220 may be moved up and down within the entire area 310 having a size corresponding to the resolution of the rear image 210. Additionally or alternatively, although not shown, the position of the setting area 320 may be moved left and right within the entire area 310. Accordingly, the field of view image 220 may be detected within the rear image 210 based on the position of the setting area 320 in the entire area 310.

According to some embodiments, the camera device 110 and the digital rear mirror device 120 may communicate in a serial transmission manner. In this case, the camera device 110 may include a serializer, and the digital rear mirror device 120 may include a deserializer. The serializer and the deserializer may communicate bidirectionally. Here, there may be a first channel from the serializer to the deserializer and a second channel (which may also be referred to as a back channel) from the deserializer to the serializer between the serializer and the deserializer. Through the first channel, the rear image 210 or the field of view image 220 may be transmitted. Here, the serializer may convert the rear image 210 or the field of view image 220 from parallel data to serial data, and the deserializer may convert the rear image 210 or the field of view image 220 from serial data to parallel data. Meanwhile, through the second channel, a position of the field of view image 220 to be detected in the rear image 210 determined based on a user input, that is, a position of a setting area 320 in the entire area 310, or a user input may be transmitted.

A method of operating a digital rear mirror system 100 according to the first embodiment will now be described.

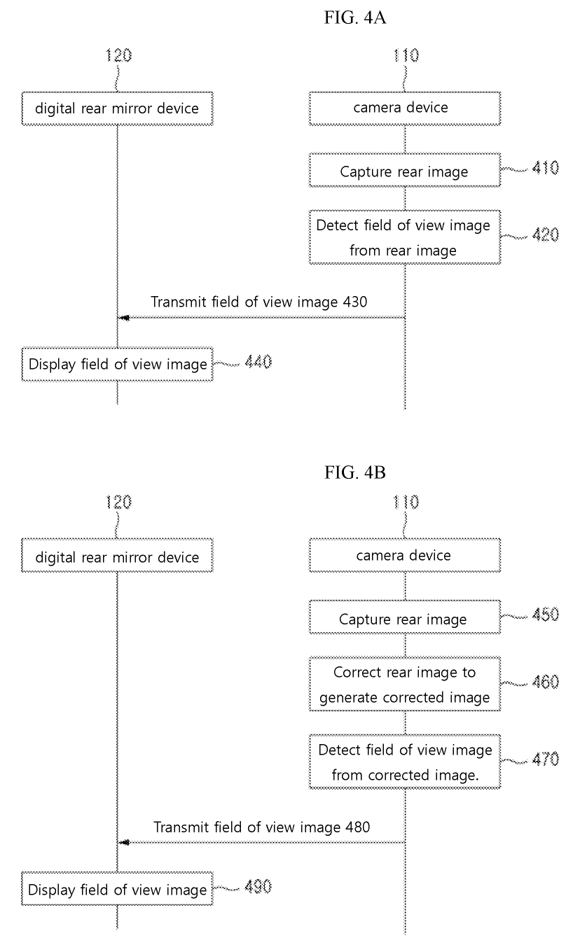

FIG. 4A is a flowchart illustrating a display method of the digital rear mirror system 100 according to the first embodiment.

Referring to FIG. 4A, in operation 410, the camera device 110 may capture a rear image 210 of the vehicle. Here, the rear image 210 may have a resolution of the camera device 110. Then, in operation 420, the camera device 110 may detect a field of view image 220 from the rear image 210. That is, the camera device 110 may detect the field of view image 220 from the rear image 210 based on the resolution of the display area. Here, the field of view image 220 may have a resolution of the display area of the digital rear mirror device 120. For example, as shown in FIG. 2, as the resolution of the display area of the digital rear mirror device 120 is lower than the resolution of the camera device 110, the camera device 110 may divide the rear image 210 into the field of view image 220 and the remaining image 230, and detect the field of view image 220 from the rear image 210.

Next, in operation 430, the camera device 110 may transmit the field of view image 220 to the digital rear mirror device 120. Here, the camera device 110 may transmit the field of view image 220 to the digital rear mirror device 120 in a serial transmission manner. The camera device 110 may transfer the field of view image 220 to the digital rear mirror device 120 through a first channel. A serializer provided in the camera device 110 is capable of transferring the field of view image 220 to a deserializer provided in the digital rear mirror device 120. The field of view image 220 transmitted from the camera device 110 to the digital rear mirror device 120 may be parallel data. The serializer may convert the parallel data of the field of view image 220 into serial data and transmit it to the deserializer. The deserializer may receive the field of view image 220 through the first channel. The deserializer may convert the field of view image 220 from serial data to parallel data.

Accordingly, in operation 440, the digital rear mirror device 120 may display the field of view image 220. That is, the digital rear mirror device 120 may display the field of view image 220 in a display area. To this end, the digital rear mirror device 120 may resize the field of view image 220 to the size of the display area. FIG. 4B is a flowchart illustrating another display method of the digital rear mirror system 100 according to the first embodiment.

Referring to FIG. 4B, in operation 450, the camera device 110 may capture a rear image 210 of the vehicle. Here, the rear image 210 may have a resolution of the camera device 110. Then, in operation 460, the camera device 110 may correct the rear image 210 to generate a corrected image. The corrected image may be an image having a size larger than that of the rear image 210. Thereafter, in operation 470, the camera device 110 may set only an area having a lot of information in the corrected image as an area of interest, and may detect only the area of interest as the field of view image 220 by cropping only information of non-areas of interest. Here, the field of view image 220 may have a resolution of the display area of the digital rear mirror device 120.

Next, in operation 480, the camera device 110 may transmit the field of view image 220 to the digital rear mirror device 120. Here, the camera device 110 may transmit the field of view image 220 to the digital rear mirror device 120 in a serial transmission manner. The camera device 110 may transfer the field of view image 220 to the digital rear mirror device 120 through a first channel. A serializer provided in the camera device 110 is capable of transferring the field of view image 220 to a deserializer provided in the digital rear mirror device 120. The field of view image 220 transmitted from the camera device 110 to the digital rear mirror device 120 may be parallel data. The serializer may convert the parallel data of the field of view image 220 into serial data and transmit it to the deserializer. The deserializer may receive the field of view image 220 through the first channel. The deserializer may convert the field of view image 220 from serial data to parallel data.

Accordingly, in operation 490, the digital rear mirror device 120 may display the field of view image 220. That is, the digital rear mirror device 120 may display the field of view image 220 in a display area. To this end, the digital rear mirror device 120 may resize the field of view image 220 to the size of the display area.

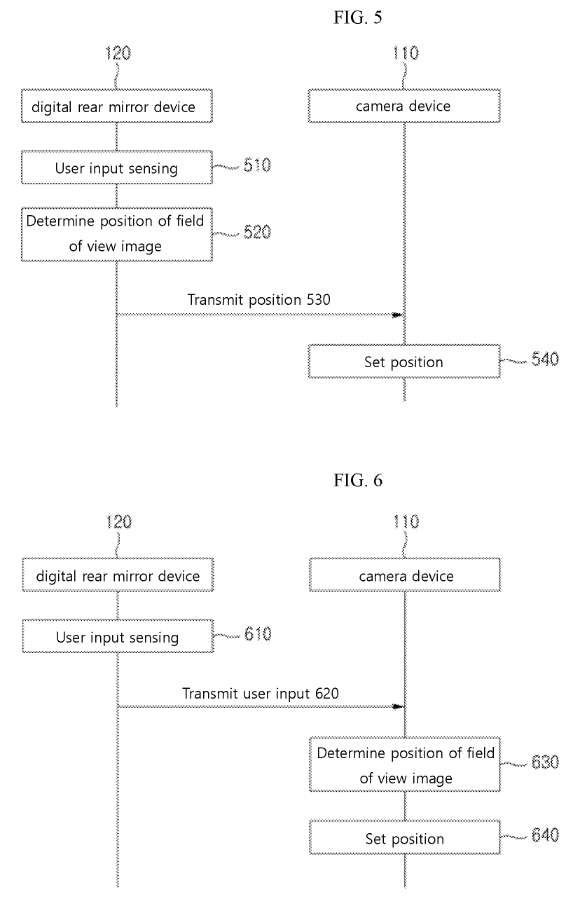

FIG. 5 is a flowchart illustrating a method of setting the digital rear mirror system 100 according to the first embodiment.

Referring to FIG. 5, in operation 510, the digital rear mirror device 120 may detect a user input. For example, the user input may include at least one of a key (e.g., a hard key or a soft key) input or a voice input. Specifically, while the digital rear mirror device 120 displays the field of view image 220 in the display area, the user may determine whether the field of view image 220 of the display area matches a desired viewing angle. If not, the user may request a desired viewing angle through a user input.

In response to this, in operation 520, the digital rear mirror device 120 may determine the position of the field of view image 220 to be detected in the rear image 210. That is, the digital rear mirror device 120 may determine, based on a user input, the position of the field of view image 220 to be detected from the rear image 210 according to a required viewing angle. For example, as shown in FIG. 3, the digital rear mirror device 120 may adjust the position of the setting area 320 having a size corresponding to the resolution of the field of view image 220 within the entire area 310 having a size corresponding to the resolution of the rear image 210.

Next, in operation 530, the digital rear mirror device 120 may transmit the corresponding position, that is, the position of the setting area 320 in the entire area 310 to the camera device 110. Here, the digital rear mirror device 120 may transmit a position of the setting area 320 in the entire area 310 to the camera device 110 in a serial transmission manner. The digital rear mirror device 120 may transmit the position of the setting area 320 to the camera device 110 through the second channel. The deserializer provided in the digital rear mirror device 120 may transmit the position of the setting area 320 to the serializer provided in the camera device 110.

Accordingly, in operation 540, the serializer provided in the camera device 110 may receive the setting area 320. The camera device 110 may set the corresponding position, that is, the position of the setting area 320 in the entire area 310. Therefore, the camera device 110 may later detect the field of view image 220 in the rear image 210 by using the position of the setting area 320 in the entire area 310. In this way, finally, the position of a field of view image 220 to be detected in the rear image 210, that is, a position of the setting area 220 in the entire area 310, may be set in the camera device 110 at a viewing angle desired by the user.

FIG. 6 is a flowchart illustrating another setting method of the digital rear mirror system 100 according to the first embodiment.

Referring to FIG. 6, in operation 610, the digital rear mirror device 120 may detect a user input. For example, the user input may include at least one of a key (e.g., a hard key or a soft key) input or a voice input. Specifically, while the digital rear mirror device 120 displays the field of view image 220 in the display area, the user may determine whether the field of view image 220 of the display area matches a desired viewing angle. If not, the user may request a desired viewing angle through a user input.

Next, in operation 620, the digital rear mirror device 120 may transmit a user input to the camera device 110. Here, the digital rear mirror device 120 may transmit the user input to the camera device 110 in a serial transmission manner. The digital rear mirror device 120 may transmit the user input to the camera device 110 through the second channel. The deserializer provided in the digital rear mirror device 120 may transmit the user input to the serializer provided in the camera device 110. In response, in operation 630, the serializer provided in the camera device 110 may receive the user input. The camera device 110 may determine the position of the field of view image 220 to be detected in the rear image 210. That is, the camera device 110 may, based on the user input, determine the position of the field of view image 220 to be detected in the rear image 210 according to a required viewing angle. For example, as shown in FIG. 3, the camera device 110 may adjust the position of a setting area 320 having a size corresponding to the resolution of the field of view image 220 within an entire area 310 having a size corresponding to the resolution of the rear image 210.

Accordingly, in operation 640, the camera device 110 may set the corresponding position, that is, the position of the setting area 320 in the entire area 310. Therefore, the camera device 110 may later detect the field of view image 220 in the rear image 210 by using the position of the setting area 320 in the entire area 310. In this way, finally, the position of a field of view image 220 to be detected in the rear image 210, that is, a position of the setting area 220 in the entire area 310, may be set in the camera device 110 at a viewing angle desired by the user.

A method of operating the digital rear mirror system 100 according to the second embodiment will now be described.

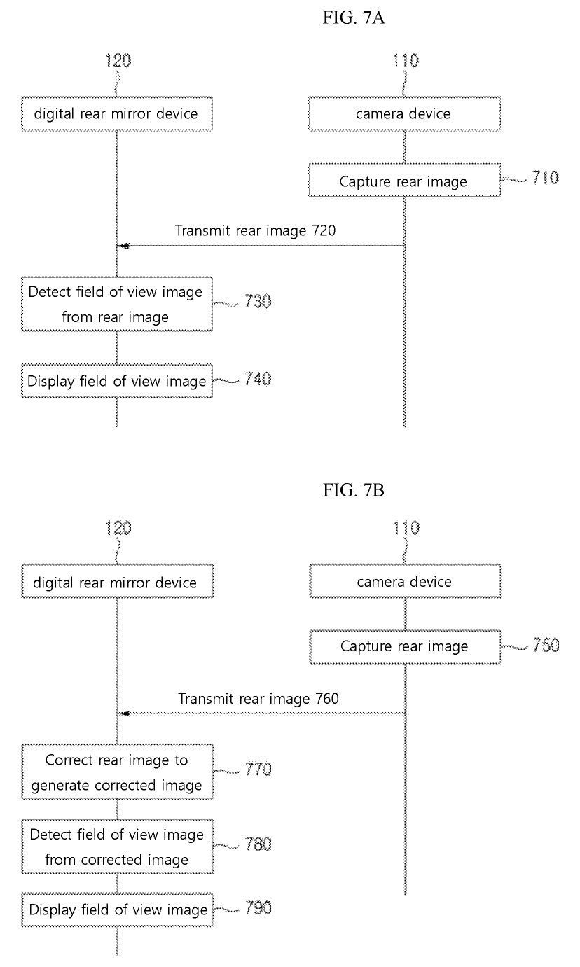

FIG. 7A is a flowchart illustrating a display method of the digital rear mirror system 100 according to a second embodiment.

Referring to FIG. 7A, in operation 710, the camera device 110 may capture a rear image 210 of the vehicle. Here, the rear image 210 may have a resolution of the camera device 110. Then, in operation 720, the camera device 110 may transmit the rear image 210 to the digital rear mirror device 120. Here, the camera device 110 may transmit the rear image 210 to the digital rear mirror device 120 in a serial transmission manner. The camera device 110 may transmit the rear image 210 to the digital rear mirror device 120 through a first channel. A serializer provided in the camera device 110 may transmit the rear image 210 to a deserializer provided in the digital rear mirror device 120. The rear image 210 transmitted from the camera device 110 to the digital rear mirror device 120 may be parallel data. The serializer may convert parallel data of the rear image 210 to serial data and transmit the serial data to the deserializer. The deserializer may receive the rear image 210 through the first channel. The deserializer may convert the rear image 210 from serial data to parallel data.

Next, in operation 730, the digital rear mirror device 120 may detect the field of view image 220 from the rear image 210. That is, the digital rear mirror device 120 may detect, based on the resolution of the display area, the field of view image 220 from the rear image 210. Here, the field of view image 220 may have a resolution of the display area of the digital rear mirror device 120. For example, as shown in FIG. 2, as the resolution of the display area of the digital rear mirror device 120 is lower than the resolution of the camera device 110, the digital rear mirror device 120 may divide the rear image 210 into the field of view image 220 and the remaining image 230, and detect the field of view image 220 from the rear image 210.

Accordingly, in operation 740, the digital rear mirror device 120 may display the field of view image 220. That is, the digital rear mirror device 120 may display the field of view image 220 in a display area. To this end, the digital rear mirror device 120 may resize the field of view image 220 to the size of the display area.

FIG. 7B is a flowchart illustrating another display method of the digital rear mirror system 100 according to the second embodiment.

Referring to FIG. 7B, in operation 750, the camera device 110 may capture a rear image 210 of the vehicle. Here, the rear image 210 may have a resolution of the camera device 110. Then, in operation 760, the camera device 110 may transmit the rear image 210 to the digital rear mirror device 120. Here, the camera device 110 may transmit the rear image 210 to the digital rear mirror device 120 in a serial transmission manner. The camera device 110 may transmit the rear image 210 to the digital rear mirror device 120 through a first channel. A serializer provided in the camera device 110 may transmit the rear image 210 to a deserializer provided in the digital rear mirror device 120. The rear image 210 transmitted from the camera device 110 to the digital rear mirror device 120 may be parallel data. The serializer may convert parallel data of the rear image 210 to serial data and transmit the serial data to the deserializer. The deserializer may receive the rear image 210 through the first channel. The deserializer may convert the rear image 210 from serial data to parallel data.

Next, in operation 770, the digital rear mirror device 120 may correct the rear image 210 to generate a corrected image. The corrected image may be an image having a size larger than that of the rear image 210. In operation 780, the digital rear mirror device 120 may set only an area having a lot of information in the corrected image as an area of interest, and may detect only the area of interest as a field of view image 220 by cropping only information of non-areas of interest. Here, the field of view image 220 may have a resolution of the display area of the digital rear mirror device 120.

Accordingly, in operation 790, the digital rear mirror device 120 may display the field of view image 220. That is, the digital rear mirror device 120 may display the field of view image 220 in a display area. To this end, the digital rear mirror device 120 may resize the field of view image 220 to the size of the display area.

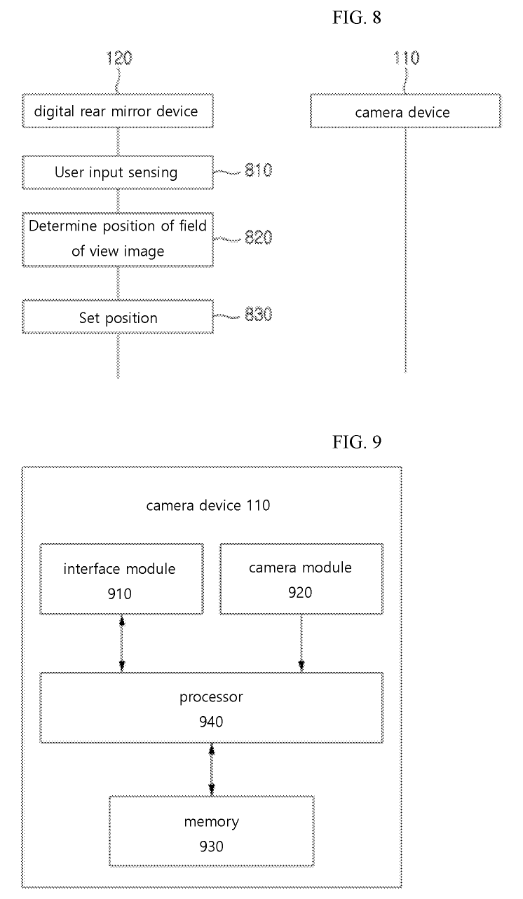

FIG. 8 is a flowchart illustrating a method of setting the digital rear mirror system 100 according to the second embodiment.

Referring to FIG. 8, in operation 810, the digital rear mirror device 120 may detect a user input. For example, the user input may include at least one of a key (e.g., a hard key or a soft key) input or a voice input. Specifically, while the digital rear mirror device 120 displays the field of view image 220 in the display area, the user may determine whether the field of view image 220 of the display area matches a desired viewing angle. If not, the user may request a desired viewing angle through a user input.

In response to this, in operation 820, the digital rear mirror device 120 may determine the position of the field of view image 220 to be detected in the rear image 210. That is, the digital rear mirror device 120 may determine, based on a user input, the position of the field of view image 220 to be detected from the rear image 210 according to a required viewing angle. For example, as shown in FIG. 3, the digital rear mirror device 120 may adjust the position of the setting area 320 having a size corresponding to the resolution of the field of view image 220 within the entire area 310 having a size corresponding to the resolution of the rear image 210.

Accordingly, in operation 830, the digital rear mirror device 120 may set the corresponding position, that is, the position of the setting area 320 in the entire area 310. Therefore, the digital rear mirror device 120 may subsequently detect the field of view image 220 in the rear image 210 by using the position of the setting area 320 in the entire area 310. In this way, finally, the position of the field of view image 220 to be detected in the rear image 210, that is, the position of the setting area 320 in the entire area 310, may be set in the digital rear mirror device 120 at a viewing angle desired by the user.

A camera device 110 and a method of operating the same according to various embodiments will now be described.

FIG. 9 is a block diagram illustrating an internal configuration of the camera device 110 according to various embodiments.

Referring to FIG. 9, the camera device 110 may be mounted on the vehicle together with the digital rear mirror device 120, and may be communicatively connected to the digital rear mirror device 120. In this case, the camera device 110 may be mounted on a rear side of the vehicle so as to face a rear side of the vehicle. Specifically, the camera device 110 may include at least one of an interface module 910, a camera module 920, a memory 930, or a processor 940. In some embodiments, at least one of components of the camera device 110 may be omitted, and at least one other component may be added. In some embodiments, at least two of the components of the camera device 110 may be implemented as one integrated circuit.

The interface module 910 may be provided for connection with an external device. Specifically, the interface module 910 may support a designated protocol that may be wired or wirelessly connected to an external device. For example, the interface module 910 may include at least one of a high-definition multimedia interface (HDMI), a universal serial bus (USB) interface, an SD card interface, or an audio interface. According to various embodiments, the interface module 910 may include a serializer. The serializer may communicate with a deserializer of the digital rear mirror device 120 in both directions. Here, there may be a first channel from the serializer to the deserializer and a second channel (which may also be referred to as a back channel) from the deserializer to the serializer between the serializer and the deserializer.

The camera module 920 may capture an image. For example, the camera module 920 may include at least one of one or more lenses, an image sensor, or a flash. According to various embodiments, as the camera device 110 is mounted on the vehicle to face the rear of the vehicle, the camera module 920 may capture the rear image 210 of the vehicle.

The memory 930 may store a variety of data used by at least one component of the camera device 110. For example, the memory 930 may include at least one of a volatile memory or a non-volatile memory. The data may include at least one program and input data or output data related thereto. The program may be stored in the memory 930 as software including at least one instruction, and may include, for example, at least one of an operating system, middleware, or an application. According to the first embodiment, the memory 930 may store setting information for the field of view image 220 to be detected in the rear image 210. Here, the setting information may include at least one of a resolution of the field of view image 220 or a size corresponding thereto, or a position to be detected within the rear image 210, that is, a position of a setting area 320 corresponding to a resolution of the field of view image 220 within the entire area 310 corresponding to the resolution of the rear image 210.

The processor 940 may control at least one component of the camera device 110 by executing a program in the memory 930. Accordingly, the processor 940 may perform data processing or an operation. In this case, the processor 940 may execute an instruction stored in the memory 930. In particular, the processor 940 may include an image signal processor (ISP).

According to the first embodiment, the processor 940 may capture the rear image 210 through the camera module 920 and detect the field of view image 220 from the rear image 210 based on the setting information. At this time, an image signal processor may not only perform a general image processing function, but also detect the field of view image 220 from the rear image 210. In an embodiment, the processor 940 may directly detect the field of view image 220 from the rear image 210. In another embodiment, the processor 940 may generate a corrected image by correcting the rear image 210 and detect the field of view image 220 from the corrected image. Here, the processor 940 may store the rear image 210 or the field of view image 220 in the memory 930. In this case, the processor 940 may transmit the field of view image 220 to the digital rear mirror device 120 through the interface module 910. Here, a serializer of the interface module 910 may convert the field of view image 220 from parallel data to serial data. Then, the serializer of the interface module 910 may transmit the field of view image 220 through a first channel. In this embodiment, the processor 940 may change a position of the field of view image 220 to be detected in the rear image 210 among the setting information, that is, a position of the setting area 320 in the entire area 310. Here, the serializer of the interface module 910 may directly receive the corresponding position through a second channel or receive a user input. When a user input is received, the processor 940 may change the corresponding position based on the user input.

According to the second embodiment, the processor 940 may capture the rear image 210 through the camera module 920 and transmit the rear image 210 to the digital rear mirror device 120 through the interface module 910. Here, the processor 940 may store the rear image 210 in the memory 930. A serializer of the interface module 910 may convert the rear image 210 from parallel data to serial data. The serializer of the interface module 910 may transmit the rear image 210 through a first channel.

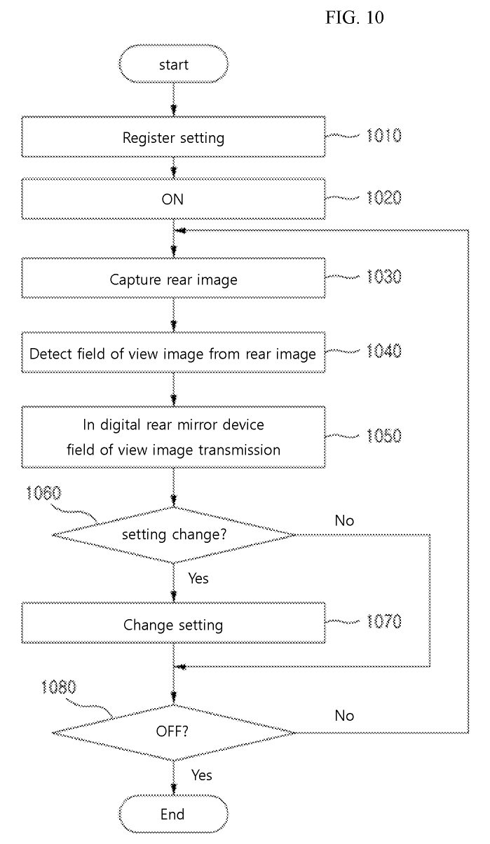

FIG. 10 is a flowchart illustrating an operation method of the camera device 110 according to the first embodiment.

Referring to FIG. 10, in operation 1010, setting information may be registered in the camera device 110. For example, when the digital rear mirror system 100 is initially installed in a vehicle, the processor 940 may store arbitrary setting information in the memory 930. Here, the processor 940 may obtain arbitrary setting information from the digital rear mirror device 120 through the interface module 910. For another example, when the camera device 110 is manufactured, arbitrary setting information may be stored in the memory 930. Here, the setting information may include at least one of a resolution of the field of view image 220 or a size corresponding thereto, or a position to be detected within the rear image 210, that is, a position of a setting area 320 corresponding to a resolution of the field of view image 220 within the entire area 310 corresponding to the resolution of the rear image 210.

Next, in operation 1020, the camera device 110 may be turned on. Specifically, as power is supplied to the camera device 110, the processor 940 may be booted. At this time, the processor 940 may call setting information from the memory 930. For example, when the vehicle is started, power may be supplied from the vehicle to the camera device 110. As another example, when the digital rear mirror device 120 is turned on based on a user input, power may be supplied from the vehicle to the camera device 110.

Next, in operation 1030, the camera device 110 may capture a rear image 210. Specifically, the processor 940 may capture the rear image 210 through the camera module 920. Here, the rear image 210 may have a resolution of the camera device 110.

Next, in operation 1040, the camera device 110 may detect the field of view image 220 from the rear image 210. Specifically, the processor 940 may detect the field of view image 220 from the rear image 210 using setting information of the memory 930. In an embodiment, the processor 940 may directly detect the field of view image 220 from the rear image 210. In another embodiment, the processor 940 may generate a corrected image by correcting the rear image 210 and detect the field of view image 220 from the corrected image. The corrected image may be an image having a size larger than that of the rear image 210. The processor 940 may detect only the area of interest as the field of view image 220 by setting only an area having a lot of information in the corrected image as the area of interest and cropping only the information of the non-areas of interest. Here, the field of view image 220 may have a resolution of the display area of the digital rear mirror device 120. In addition, the field of view image 220 may have an arbitrary field of view angle. The arbitrary field of view angle may be a field of view angle desired by a user. For example, as shown in FIG. 2, as the resolution of the display area of the digital rear mirror device 120 is lower than the resolution of the camera device 110, the processor 940 may divide the rear image 210 into the field of view image 220 and a remaining image 230, and detect the field of view image 220 from the rear image 210.

Next, in operation 1050, the camera device 110 may transmit the field of view image 220 to the digital rear mirror device 120. Specifically, the processor 940 may transmit the field of view image 220 to the digital rear mirror device 120 through the interface module 910.

Next, in operation 1060, the camera device 110 may sense a request for changing setting information. Specifically, when the request is received from the digital rear mirror device 120 through the interface module 910, the processor 940 may sense the request. In response, in operation 1070, the camera device 110 may change the setting information. Specifically, the processor 940 may change a position of the field of view image 220 to be detected in the rear image 210 among the setting information of the memory 930, that is, a position of the setting area 320 in the entire area 310. According to an embodiment, the request may include a position of the field of view image 220 to be detected in the rear image 210. That is, the digital rear mirror device 120 may determine the position based on a user input and transmit the position to the camera device 110. Accordingly, the processor 940 may change the setting information by using the position. According to another embodiment, the request may include a user input. That is, the digital rear mirror device 120 may transmit a user input to the camera device 110. Accordingly, the processor 940 may determine a position based on the user input and change the setting information using the position.

Next, in operation 1080, when the camera device 110 is not turned off, the camera device 110 may repeatedly perform at least some of operations 1030 to 1070. Specifically, when the already registered or changed setting information has a viewing angle desired by a user, the processor 940 may repeatedly perform only operations 1030 to 1050. The processor 940 may continue to capture the rear image 210, detect the field of view image 220 from the rear image 210, and transmit the field of view image 220 to the digital rear mirror device 120. At this time, when the setting information is changed, the processor 940 may detect the field of view image 220 from the rear image 210 by using the changed setting information in operation 1040. Meanwhile, when the already registered or changed setting information does not have a viewing angle desired by the user, the processor 940 may repeatedly perform operations 1060 and 1070 as well as operations 1030 to 1050. The processor 940 may additionally change the setting information in operations 1060 and 1070.

Meanwhile, in operation 1080, the camera device 110 may be turned off. In operation 1060, a request for changing setting information is not detected, and the camera device 110 may be turned off. Alternatively, after changing the setting information in operation 1070, the camera device 110 may be turned off. Specifically, when power is not supplied to the camera device 110, the processor 940 may be turned off. For example, when an engine of a vehicle is turned off, power supply from the vehicle to the camera device 110 may be stopped. For another example, when the digital rear mirror device 120 is turned off based on a user input, power supply from the vehicle to the camera device 110 may be stopped.

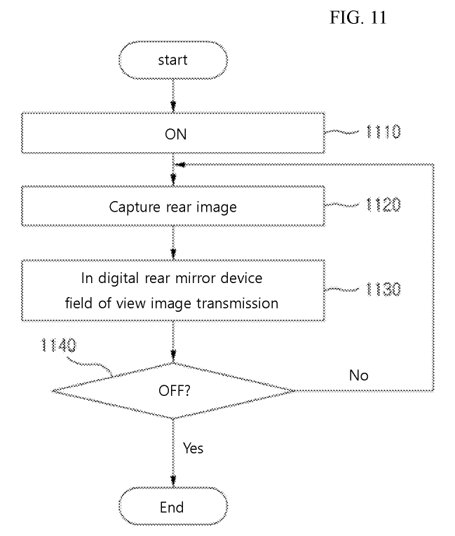

FIG. 11 is a flowchart illustrating an operation method of the camera device 110 according to the second embodiment.

Referring to FIG. 11, in operation 1110, the camera device 110 may be turned on. Specifically, as power is supplied to the camera device 110, the processor 940 may be booted. At this time, the processor 940 may call setting information from the memory 930. For example, when the vehicle is started, power may be supplied from the vehicle to the camera device 110. For another example, when the digital rear mirror device 120 is turned on based on a user input, power may be supplied from the vehicle to the camera device 110.

Next, in operation 1120, the camera device 110 may capture a rear image 210. Specifically, the processor 940 may capture the rear image 210 through the camera module 920. Here, the rear image 210 may have a resolution of the camera device 110.

Next, in operation 1130, the camera device 110 may transmit the rear image 210 to the digital rear mirror device 120. Specifically, the processor 940 may transmit the rear image 210 to the digital rear mirror device 120 through the interface module 910.

Next, in operation 1140, when the camera device 110 is not turned off, the camera device 110 may repeatedly perform operations 1120 and 1130. Specifically, the processor 940 may continue to capture the rear image 210 and transmit the rear image 210 to the digital rear mirror device 120.

Meanwhile, in operation 1140, the camera device 110 may be turned off. Specifically, when power is not supplied to the camera device 110, the processor 940 may be turned off. For example, when an engine of a vehicle is turned off, power supply from the vehicle to the camera device 110 may be stopped. For another example, when the digital rear mirror device 120 is turned off based on a user input, power supply from the vehicle to the camera device 110 may be stopped.

A digital rear mirror device 120 and a method of operating the same according to various embodiments will now be described.

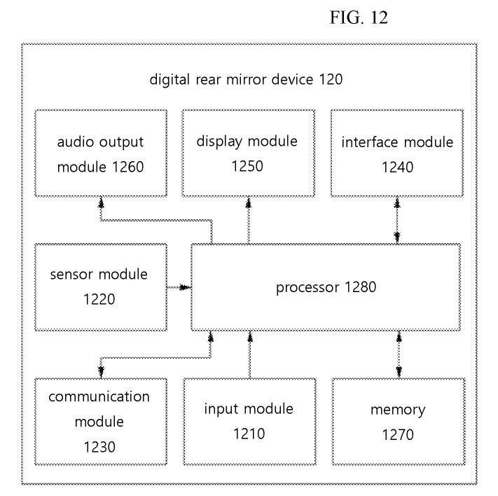

FIG. 12 is a block diagram illustrating an internal configuration of a digital rear mirror device 120 according to various embodiments.

Referring to FIG. 12, the digital rear mirror device 120 is mounted inside the vehicle together with the camera device 110, and may be communicatively connected to the camera device 110. Specifically, the digital rear mirror device 120 may include at least one of an input module 1210, a sensor module 1220, a communication module 1230, an interface module 1240, a display module 1250, an audio output module 1260, a memory 1270, or a processor 1280. In some embodiments, at least one of the components of the digital rear mirror device 120 may be omitted, and at least one other component may be added. In some embodiments, at least two of the components of the digital rear mirror device 120 may be implemented as one integrated circuit. In an embodiment, all components of the digital rear mirror device 120 may be housed within a single housing, in which case the housing may be disposed in front of the vehicle, particularly in the case of a vehicle with an interior space, in front of the driver's seat in the interior space. That is, the digital rear mirror device 120 may be disposed at a position of a conventional rear mirror. In other embodiments, only the display module 1250 may be accommodated in a single housing, or the display module 1250 and at least one other component (e.g., the input module 1210 and the sensor module 1220) may be accommodated within a single housing, and in this case, the housing may be disposed in front of the vehicle, especially in the case of a vehicle having an interior space, in front of the driver's seat in the interior space. That is, the display module 1250 may be disposed at a conventional rear mirror position. Meanwhile, the remaining components may be disposed at a separate position of the vehicle.

The input module 1210 may input a signal to be used for at least one component of the digital rear mirror device 120. For example, the input module 1210 may include at least one of a key, a button, a keyboard, a keypad, a mouse, a joystick, or a microphone. In some embodiments, the input module 1210 may include at least one of touch circuitry configured to sense a touch or sensor circuitry configured to measure the intensity of a force generated by the touch.

The sensor module 1220 may generate an electrical signal or data value corresponding to an internal operating state (e.g., power or temperature) of the digital rear mirror device 120 or an external environmental state. For example, the sensor module 1220 may include at least one of a radar sensor, a LIDAR sensor, a motion sensor, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The communication module 1230 may perform communication with an external device. The communication module 1230 establishes a communication channel between the digital rear mirror device 120 and the external device, and may perform communication with the external device through the communication channel. Here, the external device may include at least one of a satellite, a base station, a server, or another electronic device. The communication module 1230 may include at least one of a wired communication module or a wireless communication module. The wired communication module may be connected to the external device through a connection terminal by wire to communicate by wire. The wireless communication module may include at least one of a short-range communication module or a long-range communication module. The short-range communication module may communicate with an external device by a short-range communication method. For example, the short-range communication method may include at least one of Bluetooth, WiFi direct, or infrared data association (IrDA). The long-range communication module may communicate with external devices by a long-range communication method. Here, the long-range communication module may communicate with external devices through a network. For example, the network may include at least one of a cellular network, the Internet, or a computer network such as a local area network (LAN) or a wide area network (WAN).

According to various embodiments, at least one of the input module 1210, the sensor module 1220, or the communication module 1230 may generate a user input. For example, the user input may include at least one of a key (e.g., a hard key or a soft key) input or a voice input. In an embodiment, any sensor of the input module 1210 or the sensor module 1220 may generate the user input based on a signal directly input from the user. For example, at least one of a motion sensor, a gesture sensor, a proximity sensor, a temperature sensor, or an illuminance sensor may be utilized for the user input. In another embodiment, the communication module 1230 may generate the user input based on a signal input from another electronic device used by the user.

The interface module 1240 may be provided for connection with an external device. Specifically, the interface module 1240 may support a designated protocol that may be wired or wirelessly connected to an external device. For example, the interface module 1240 may include at least one of HDMI, a USB interface, an SD card interface, or an audio interface. According to various embodiments, the interface module 1240 may include a deserializer. The deserializer may communicate bidirectionally with a serializer of the camera device 110. Here, there may be a first channel from the serializer to the deserializer and a second channel (which may also be referred to as a back channel) from the deserializer to the serializer between the serializer and the deserializer.

The display module 1250 may be provided to display the field of view image 220 detected from the rear image 210 of the vehicle. To this end, the display module 1250 has a display area of a predetermined size and resolution, and the resolution of the field of view image 220 may be the same as the resolution of the display area. For example, the display module 1250 may include at least one of a display, a hologram device, or a projector. As an example, the display module 1250 may be assembled with at least one of a touch circuit or a sensor circuit of the input module 1210 and implemented as a touch screen. According to various embodiments, the display module 1250 may be disposed in front of the vehicle, particularly in the case of a vehicle having an internal space, in front of a driver's seat in the internal space. That is, the display module 1250 may be disposed at a position of a general rear mirror. Additionally, the display module 1250 may further include another display area disposed around the display area for the field of view image 220.

The audio output module 1260 may output an audio signal generated from the digital rear mirror device 120. For example, the audio output module 1260 may include at least one of a speaker or a receiver.

The memory 1270 may store a variety of data used by at least one component of the digital rear mirror device 120. For example, the memory 1270 may include at least one of a volatile memory or a non-volatile memory. The data may include at least one program and input data or output data related thereto. The program may be stored in the memory 1270 as software including at least one instruction, and may include, for example, at least one of an operating system, middleware, or an application. According to the second embodiment, the memory 1270 may store setting information for the field of view image 220 to be detected in the rear image 210. Here, the setting information may include at least one of a resolution of the field of view image 220 or a size corresponding thereto, or a position to be detected within the rear image 210, that is, a position of a setting area 320 corresponding to a resolution of the field of view image 220 within the entire area 310 corresponding to the resolution of the rear image 210.

The processor 1280 may control at least one component of the digital rear mirror device 120 by executing a program of the memory 1270. Accordingly, the processor 1280 may perform data processing or an operation. In this case, the processor 1280 may execute an instruction stored in the memory 1270.

According to the first embodiment, the processor 1280 may receive the field of view image 220 from the camera device 110 through the interface module 1240. Here, the deserializer of the interface module 1240 may receive the field of view image 220 through a first channel. The deserializer of the interface module 1240 may convert the field of view image 220 from serial data to parallel data. The processor 1280 may store the field of view image 220 in the memory 1270. Accordingly, the processor 1280 may display the field of view image 220 through the display module 1250. In this embodiment, the processor 1280 may cooperate with the camera device 110 via the interface module 1240 to change a position of the field of view image 220 to be detected in the rear image 210, that is, a position of the setting area 320 in the entire area 310, from among setting information registered in the camera device 110. Here, the deserializer of the interface module 1240 may directly transmit the corresponding position or transmit a user input through a second channel.

According to the second embodiment, the processor 1280 may receive the rear image 210 from the camera device 110 through the interface module 1240. Here, the deserializer of the interface module 1240 may receive the rear image 210 through the first channel. The deserializer of the interface module 1240 may convert the rear image 210 from serial data to parallel data. In this case, the processor 1280 may detect the field of view image 220 from the rear image 210 based on the setting information. In an embodiment, the processor 1280 may directly detect the field of view image 220 from the rear image 210. In another embodiment, the processor 1280 may generate a corrected image by correcting the rear image 210 and detect the field of view image 220 from the corrected image. Here, the processor 1280 may store the rear image 210 or the field of view image 220 in the memory 1270. Accordingly, the processor 1280 may display the field of view image 220 through the display module 1250. In this embodiment, the processor 1280 may change the position of the field of view image 220 to be detected in the rear image 210 among the setting information of the memory 1270, that is, the position of the setting area 320 in the entire area 310.

Additionally, the processor 1280 may analyze the rear image 210 or the field of view image 220 to detect reference information, and display the reference information together with the field of view image 220. The reference information may be information in the rear image 210 or the field of view image 220, for example, a road sign, and may be information derived from the rear image 210 or the field of view image 220, for example, a distance from an adjacent vehicle, a speed of an adjacent vehicle, and the like. For example, the processor 1280 may display the field of view image 220 and the reference information in a display area. For another example, the processor 1280 may display the reference information in another display area while displaying the field of view image 220 in the display area. Here, the reference information may be displayed in various graphical representations, for example, text, symbols, images, and the like.

Additionally, the processor 1280 may adjust the display module 1250 or cause the camera device 110 to control the camera module 920 by using a sensing input through the sensor module 1220. For example, the processor 1280 may sense a sensing input indicating ambient brightness or the like input through an illuminance sensor or the like. In this case, the processor 1280 may change at least one of the brightness or the reflectance of the display module 1250 by using the sensing input. Alternatively, the processor 1280 may cause the camera device 110 to change the light sensitivity of the camera module 920 or the brightness of the rear image 210 captured through the camera module 920 based on the sensing input. Here, the processor 1280 may determine a target value for the light sensitivity of the camera module 920 or the brightness of the rear image 210 and transmit the target value to the camera device 110, or may transmit the sensing input to the camera device 110.

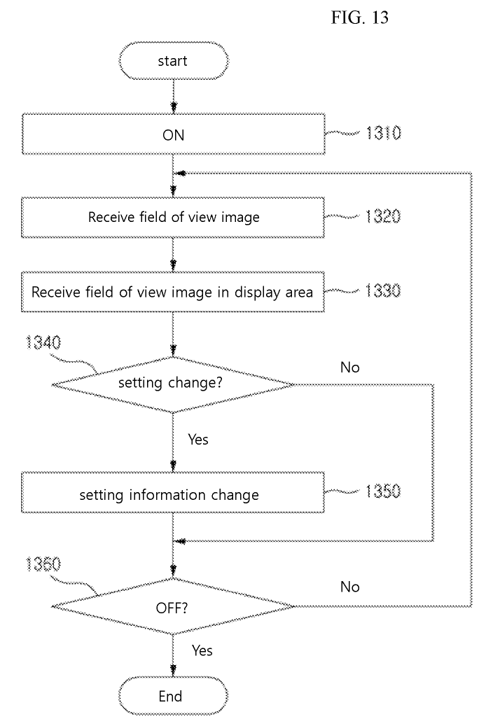

FIG. 13 is a flowchart illustrating a method of operating the digital rear mirror device 120 according to the first embodiment.

Referring to FIG. 13, in operation 1310, the digital rear mirror device 120 may be turned on. Specifically, the processor 1280 may be booted as power is supplied to the digital rear mirror device 120. For example, when a vehicle is started, power may be supplied from the vehicle to the digital rear mirror device 120. For another example, when power is turned on based on a user input through the input module 1210, power may be provided from the vehicle to the digital rear mirror device 120.

On the other hand, setting information may be registered in the camera device 110. For example, when the digital rear mirror system 100 is initially installed in a vehicle, the processor 940 may store arbitrary setting information in the memory 930. Here, the processor 940 may obtain arbitrary setting information from the digital rear mirror device 120 through the interface module 910. For another example, when the camera device 110 is manufactured, arbitrary setting information may be stored in the memory 930. Here, the setting information may include at least one of a resolution of the field of view image 220 or a size corresponding thereto, or a position to be detected within the rear image 210, that is, a position of a setting area 320 corresponding to a resolution of the field of view image 220 within the entire area 310 corresponding to the resolution of the rear image 210.

Next, in operation 1320, the digital rear mirror device 120 may receive a field of view image 220 from the camera device 110. Specifically, the processor 1280 may receive the field of view image from the camera device 110 through the interface module 1240. In this case, the camera device 110 may capture the rear image 210 and detect the field of view image 220 from the rear image 210 by using setting information. Here, the field of view image 220 may have a resolution of the display area of the digital rear mirror device 120. In addition, the field of view image 220 may have an arbitrary field of view angle. The arbitrary field of view angle may be a field of view angle desired by a user. Here, the deserializer of the interface module 1240 may receive the field of view image 220 through a first channel. The deserializer of the interface module 1240 may convert the field of view image 220 from serial data to parallel data. The processor 1280 may store the field of view image 220 in the memory 1270.

Next, in operation 1330, the digital rear mirror device 120 may display the field of view image 220 in the display area. Specifically, the processor 1280 may display the field of view image 220 in the display area through the display module 1250. To this end, the processor 1280 may resize the field of view image 220 to the size of the display area.

Next, in operation 1340, the digital rear mirror device 120 may detect a request to change setting information. Specifically, when a user input indicating the request is received from the user through at least one of the input module 1210, the sensor module 1220, or the communication module 1230, the processor 1280 may sense the request. In response, in operation 1350, the digital rear mirror device 120 may cause the camera device 110 to change the setting information. Specifically, the processor 1280 may cause the camera device 110 to change, in the setting information, the position of the field of view image 220 to be detected in the rear image 210, that is, the position of the setting area 320 in the entire area 310. According to an embodiment, the processor 1280 may determine the corresponding position based on the user input and transmit the corresponding position to the camera device 110 through the interface module 1240. According to another embodiment, the processor 1280 may transmit the user input to the camera device 110 through the interface module 1240. Here, the deserializer of the interface module 1240 may directly transmit the corresponding position or transmit a user input through a second channel.

Next, in operation 1360, when the digital rear mirror device 120 is not turned off, the digital rear mirror device 120 may repeatedly perform at least some of operations 1320 to 1350. Specifically, when the setting information that has already been registered or changed for the camera device 110 has a viewing angle desired by the user, the processor 1280 may repeatedly perform only operations 1320 and 1330. The processor 1280 may continue to receive the field of view image 220 from the camera device 110 and display the field of view image 220 through the display device 1250. In this case, when setting information for the camera device 110 has been changed, the field of view image 220 may be based on the changed setting information. On the other hand, when setting information that has been already registered or changed for the camera device 110 does not have the viewing angle desired by the user, the processor 1280 may repeatedly perform operations 1340 and 1350 as well as operations 1320 and 1330. The processor 1280 may cause the camera device 110 to additionally change the setting information in operations 1340 and 1350.

On the other hand, in operation 1360, the digital rear mirror device 120 may be turned off. In operation 1340, a request for changing setting information is not detected, and the digital rear mirror device 120 may be turned off. Alternatively, in operation 1350, after changing the setting information, the digital rear mirror device 120 may be turned off. Specifically, when power is not supplied to the digital rear mirror device 120, the processor 1280 may be turned off. For example, when the ignition of the vehicle is turned off, the power supply from the vehicle to the digital rear mirror device 120 may be stopped. For another example, when turned off based on a user input through the input module 1210, the power supply from the vehicle to the digital rear mirror device 120 may be stopped.

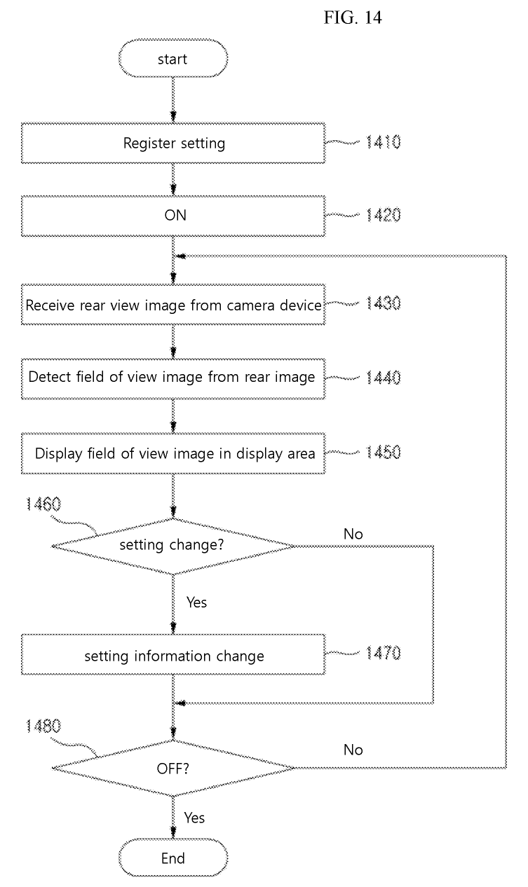

FIG. 14 is a flowchart illustrating a method of operating the digital rear mirror device 120 according to the second embodiment.

Referring to FIG. 14, in operation 1410, setting information may be registered in the digital rear mirror device 120. For example, when the digital rear mirror system 100 is initially installed in a vehicle, the processor 1280 may store arbitrary setting information in the memory 1270. Here, the processor 1280 may obtain arbitrary setting information from the digital rear mirror device 120 through the interface module 1240. As another example, when the digital rear mirror device 120 is manufactured, arbitrary setting information may be stored in the memory 1270. Here, the setting information may include at least one of a resolution of the field of view image 220 or a size corresponding thereto, or a position to be detected within the rear image 210, that is, a position of a setting area 320 corresponding to a resolution of the field of view image 220 within the entire area 310 corresponding to the resolution of the rear image 210.

Next, in operation 1420, the digital rear mirror device 120 may be turned on. Specifically, the processor 1280 may be booted as power is supplied to the digital rear mirror device 120. For example, when a vehicle is started, power may be supplied from the vehicle to the digital rear mirror device 120. For another example, when power is turned on based on a user input through the input module 1210, power may be provided from the vehicle to the digital rear mirror device 120.

Next, in operation 1430, the digital rear mirror device 120 may receive a rear image 210 from the camera device 110. Specifically, the processor 1280 may receive the rear image 210 from the camera device 110 through the interface module 1240. Here, the rear image 210 may have a resolution of the camera device 110. Here, the deserializer of the interface module 1240 may receive the rear image 210 through the first channel. The deserializer of the interface module 1240 may convert the rear image 210 from serial data to parallel data.

Next, in operation 1440, the digital rear mirror device 120 may detect the field of view image 220 from the rear image 210. Specifically, the processor 1280 may detect the field of view image 220 from the rear image 210 using setting information of the memory 1270. The corrected image may be an image having a size larger than that of the rear image 210. The processor 1280 may detect only the area of interest as the field of view image 220 by setting only an area having a lot of information in the corrected image as the area of interest and cropping only the information of the non-areas of interest. Here, the field of view image 220 may have a resolution of the display area of the digital rear mirror device 120. In addition, the field of view image 220 may have an arbitrary field of view angle. The arbitrary field of view angle may be a field of view angle desired by a user. For example, as shown in FIG. 2, as the resolution of the display area of the digital rear mirror device 120 is lower than the resolution of the camera device 110, the processor 1280 may divide the rear image 210 into the field of view image 220 and a remaining image 230, and detect the field of view image 220 from the rear image 210. Here, the processor 1280 may store the rear image 210 or the field of view image 220 in the memory 1270.

Next, in operation 1450, the digital rear mirror device 120 may display the field of view image 220 in the display area. Specifically, the processor 1280 may display the field of view image 220 in the display area through the display module 1250. To this end, the processor 1280 may resize the field of view image 220 to the size of the display area.

Next, in operation 1460, the digital rear mirror device 120 may detect a request to change setting information. Specifically, when a user input indicating the request is received from the user through at least one of the input module 1210, the sensor module 1220, or the communication module 1230, the processor 1280 may sense the request. In response, in operation 1470, the digital rear mirror device 120 may change the setting information of the memory 1270. Specifically, the processor 1280 may change the position of the field of view image 220 to be detected in the rear image 210, that is, the position of the setting area 320 in the entire area 310 from among the setting information.

Next, in operation 1480, when the digital rear mirror device 120 is not turned off, the digital rear mirror device 120 may repeatedly perform at least some of operations 1430 to 1470. Specifically, when the already registered or changed setting information has a viewing angle desired by the user, the processor 1280 may repeatedly perform only operations 1430 and 1450. The processor 1280 may continue to receive the rear image 210 from the camera device 110, detect the viewing image 220 from the rear image 210, and display the viewing image 220 through the display device 1250. At this time, when the setting information is changed, the processor 1280 may detect the field of view image 220 from the rear image 210 by using the changed setting information in operation 1440. On the other hand, when the already registered or changed setting information does not have the user's desired viewing angle, the processor 1280 may repeatedly perform operations 1460 and 1470 as well as operations 1430 to 1450. The processor 1280 may additionally change the setting information in operations 1460 and 1470.

On the other hand, in operation 1480, the digital rear mirror device 120 may be turned off. In operation 1460, a request for changing setting information is not detected, and the digital rear mirror device 120 may be turned off. Alternatively, in operation 1470, after changing the setting information, the digital rear mirror device 120 may be turned off. Specifically, when power is not supplied to the digital rear mirror device 120, the processor 1280 may be turned off. For example, when the ignition of the vehicle is turned off, the power supply from the vehicle to the digital rear mirror device 120 may be stopped. On the other hand, in operation 1480, the digital rear mirror device 120 may be turned off.

According to the present disclosure, the digital rear mirror device 120 displays the viewing image 220 detected from the rear image 210 of the vehicle captured by the camera device 110, so that an unobstructed rear view may be provided to the driver of the vehicle. According to the first embodiment, when the camera device 110 detects the viewing image 220 from the rear image 210, the viewing image 220 is transmitted from the camera device 110 to the digital rear mirror device 120, so that a transmission load between the digital rear mirror device 120 and the camera device 110 may be reduced. This can lead to rational component selection in implementing a digital rear mirror system, improved transmission noise between the digital rear mirror device and the camera device, and increased transmission power efficiency. According to the second embodiment, when the digital rear mirror device 120 detects the viewing image 220 from the rear image 210, the camera device 110 transmits the rear image 210 to the digital rear mirror device 120, so that a general camera device 110 may be used without change. In addition, according to the present disclosure, since the position of the viewing image 220 detected in the rear image 210 may be adjusted based on a user input, a rear view may be provided to the driver at a viewing angle desired by the driver. At this time, the driver may present a user input while checking the change in the viewing angle in real time through the digital rear mirror device 120, so that the desired viewing angle may be intuitively determined. This can lead to improved user convenience and stability in utilizing the digital rear mirror system.

In short, the present disclosure provides a digital rear mirror system 100 that provides a rear view of a vehicle and a method of operating the same.

In the present disclosure, a digital rear mirror system 100 of a vehicle may include a camera device 110 configured to capture a rear image 210 of the vehicle, and a digital rear mirror device 120 configured to display a field of view image 220 detected from the rear image 210.

According to various embodiments, the digital rear mirror device 120 may have a display area of a predetermined resolution and may be configured to display the field of view image 220 in the display area.

According to the first embodiment, the camera device 110 may be configured to detect the field of view image 220 from the rear image 210 based on the resolution of the display area.

According to this embodiment, the camera device 110 may be configured to detect the field of view image 220 from a position set based on a user input within the rear image 210.

In this embodiment, the digital rear mirror device 120 may be configured to sense a user input, determine a corresponding position based on the user input, and transmit the position to the camera device 110 so that the camera device 110 sets the corresponding position.

In this embodiment, the camera device 110 may be configured to receive a user input from the digital rear mirror device 120 and set a corresponding location based on the user input.

According to the second embodiment, the digital rear mirror device 120 may be configured to detect the field of view image 220 from the rear image 210 based on the resolution of the display area.

According to this embodiment, the digital rear mirror device 120 may be configured to detect the field of view image 220 from a location set based on a user input within the rear image 210.

In this embodiment, the digital rear mirror device 120 may be configured to detect a user input and set a corresponding position based on the user input.

In the present disclosure, a method of operating the digital rear mirror system 100 of a vehicle may include operations 410 and 710 in which the camera device 110 captures the rear image 210 of the vehicle, and operations 440 and 740 in which the digital rear mirror device 120 displays the field of view image 220 detected from the rear image 210.

According to various embodiments, the displaying of the field of view image 220 (operations 440 and 740) may include an operation in which the digital rear mirror device 120 displays the field of view image 220 through a display area of a predetermined resolution.

According to the first embodiment, the method of operating the digital rear mirror system 100 may further include operation 420 in which the camera device 110 detects the field of view image 220 from the rear image 210 based on the resolution of the display area.

According to this embodiment, the detecting of the field of view image 220 (operation 420) may include an operation in which the camera device 110 detects the field of view image 220 from a position set based on a user input within the rear image 210.

In this embodiment, the digital rear mirror device 120 may detect a user input (operation 510), determine a corresponding position based on the user input (operation 520), and transmit the position to the camera device 110 so that the camera device 110 sets the corresponding position (operations 530 and 540).

In this embodiment, the camera device 110 may be configured to receive a user input from the digital rear mirror device 120 (operations 610 and 620) and set a corresponding position based on the user input (operations 630 and 640).

According to the second embodiment, the method of operating the digital rear mirror system 100 may further include operation 730 in which the digital rear mirror device 120 detects the field of view image 220 from the rear image 210 based on a resolution of the display area.

According to this embodiment, the detecting of the field of view image 220 (operation 730) may include an operation in which the digital rear mirror device 120 detects the field of view image 220 from a position set based on a user input in the rear image 210.

In this embodiment, the digital rear mirror device 120 may be configured to sense a user input (operation 810) and set a position based on the user input (operations 820 and 830).

In the present disclosure, the camera device 110 connected to the digital rear mirror device 120 in the vehicle may include an interface module 910 communicatively connected to the digital rear mirror device 120, a camera module 920 configured to capture a rear image 210 of the vehicle, and an interface module 910 connected to the interface module 910 and the camera module 920, and configured to detect a field of view image 220 from the rear image 210 and transmit the field of view image 220 to the digital rear mirror device 120, so that the digital rear mirror device 120 displays the field of view image 220.

According to various embodiments, the processor 940 may be configured to detect the field of view image 220 from the rear image 210 based on the resolution of a display area configured to display the field of view image 220 in the digital rear mirror device 120.

According to various embodiments, the processor 940 may be configured to detect the field of view image 220 from a position set based on a user input within the rear image 210.

In an embodiment, the processor 940 may be configured to receive and set the corresponding position from the digital rear mirror device 120.

In another embodiment, the processor 940 may be configured to receive a user input from the digital rear mirror device 120 and set the corresponding position based on the user input.

In the present disclosure, a method of operating the camera device 110 connected to the digital rear mirror device 120 in a vehicle may include operation 1030 of capturing a rear image 210 of the vehicle, operation 1040 of detecting a field of view image 220 from the rear image 210, and operation 1050 of transmitting the field of view image 220 to the digital rear mirror device 120 so that the digital rear mirror device 120 displays the field of view image 220.

In the present disclosure, a digital rear mirror device (120) of a vehicle may include a display module 1250 having a display area, an interface module 1240 communicatively connected to a camera device 110 for capturing a rear image 210 of the vehicle, and a processor 1280 connected to the display module 1250 and the interface module 1240 and configured to display a field of view image 220 detected from the rear image 210 in the display area.

According to the first embodiment, the camera device 110 may be configured to detect the field of view image 220 from the rear image 210 based on a resolution of the display area, and the processor 1280 may be configured to receive the field of view image 220 from the camera device 110.

In this embodiment, the camera device 110 detects the field of view image 220 from a position set based on a user input within the rear image 210, and the processor 1280 may be configured to detect the user input, determine the corresponding position based on the user input, and transmit the corresponding position to the camera device 110, or detect the user input and transmit the user input to the camera device 110.

According to the second embodiment, the processor 1280 may be configured to receive the rear image 210 from the camera device 110 and detect the field of view image 220 from the rear image 210 based on a resolution of the display area.

According to this embodiment, the processor 1280 may be configured to detect the field of view image 220 from a position set based on a user input within the rear image 210.

In this embodiment, the processor 1280 may be configured to detect a user input and set a corresponding position based on the user input.

In the present disclosure, a method of operating a digital rear mirror device 120 of a vehicle may include confirming a field of view image 220 detected from a rear image 210 of the vehicle captured by a camera device 110 (operations 1320 and 1440), and displaying the field of view image 220 in a display area (operations 1330 and 1450).

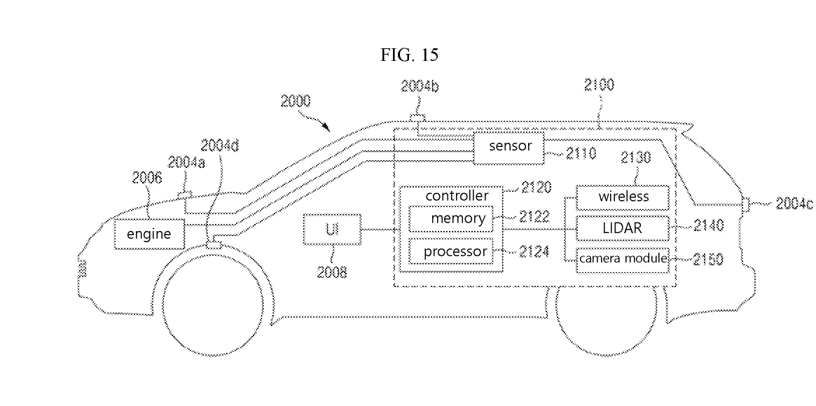

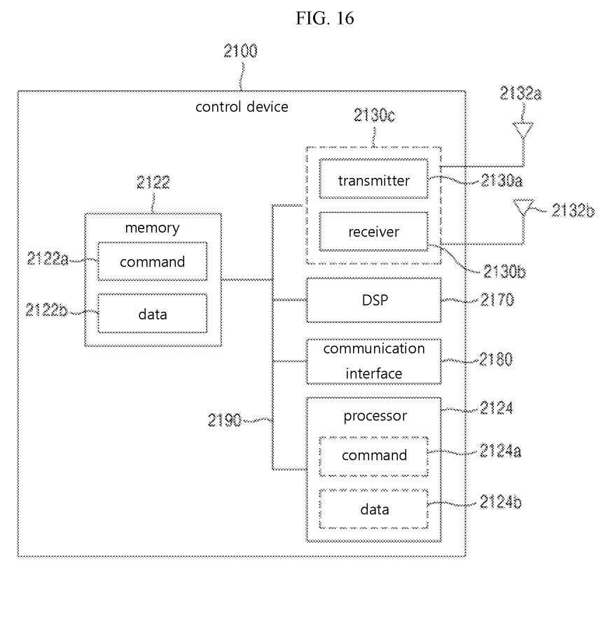

FIG. 15 is a block diagram illustrating a vehicle 2000 in which a digital rear mirror system 100 is mounted according to various embodiments. FIG. 16 is a block diagram of a control device 2100 of the vehicle of FIG. 15.

Referring to FIGS. 15 and 16, a digital rear mirror system 100 according to various embodiments may be mounted on a vehicle 2000, and the vehicle 2000 may include a control device 2100. In this case, the vehicle 2000 may be an autonomous vehicle. In some embodiments, at least one component of the camera device 110 or at least one component of the digital rear mirror device 120 may be integrated into at least one component of the control device 2100.

The control device 2100 may include a controller 2120 including a memory 2122 and a processor 2124, a sensor 2110, a wireless communication device 2130, a LIDAR 2140, and a camera module 2150.

The controller 2120 may be configured during manufacturing by a manufacturer of the vehicle, or may be further configured to perform a function of autonomous driving after manufacturing. Alternatively, a configuration for continuously performing an additional function may be included through upgrade of the controller 2120 configured during manufacturing.

The controller 2120 may transmit a control signal to a sensor 2110, an engine 2006, a user interface (UI) 2008, a wireless communication device 2130, a LIDAR 2140, and a camera module 2150 included in other configurations in the vehicle. In addition, although not shown, the control signal may also be transmitted to an acceleration device, a braking system, a steering device, or a navigation device related to driving of the vehicle.

The controller 2120 may control the engine 2006. For example, the controller 2120 may sense a speed limit of a road on which the vehicle 2000 is traveling and control the engine 2006 so that the driving speed does not exceed the speed limit, or control the engine 2006 to accelerate the driving speed of the vehicle 2000 within a range not exceeding the speed limit. In addition, when the sensing modules 2004a, 2004b, 2004c, and 2004d sense an environment outside the vehicle and transmit it to the sensor 2110, the controller 2120 may receive it and generate a signal for controlling the engine 2006 or a steering device (not shown) to control the driving of the vehicle.

The controller 2120 may control the engine 2006 or the braking system to decelerate the traveling vehicle when another vehicle or an obstacle exists in front of the vehicle, and may control a trajectory, a driving route, and a steering angle in addition to the speed. Alternatively, the controller 2120 may generate a necessary control signal according to other external environment recognition information such as a driving lane and a driving signal of the vehicle to control the driving of the vehicle.

In addition to generating its own control signal, the controller 2120 may control the driving of the vehicle by performing communication with a surrounding vehicle or a central server and transmitting a command to control peripheral devices through received information.

In addition, when the position of the camera module 2150 is changed or the angle of view is changed, it may be difficult to accurately recognize the vehicle or lane, and thus, in order to prevent this, the controller 2120 may generate a control signal for controlling the calibration of the camera module 2150. Therefore, by generating the calibration control signal to the camera module 2150, even when the mounting position of the camera module 2150 is changed due to vibration or impact generated according to the movement of the autonomous vehicle 2000, the controller 2120 may continuously maintain the normal mounting position, direction, angle of view, and the like of the camera module 2150. When the pre-stored initial mounting position, direction and angle of view information of the camera module 2150 and the initial mounting position, direction, angle of view information of the camera module 2150 measured while the autonomous vehicle 2000 is traveling are changed to be greater than or equal to a threshold value, the controller 2120 may generate the control signal to calibrate the camera module 2150.

The controller 2120 may include a memory 2122 and a processor 2124. The processor 2124 may execute software stored in the memory 2122 according to a control signal of the controller 2120. Specifically, the controller 2120 stores data and instructions for detecting a field of view image from a rear image of the vehicle 2000 in the memory 2122, and the instructions may be executed by the processor 2124 to implement one or more methods disclosed herein.

In this case, the memory 2122 may be stored in a recording medium executable by the non-volatile processor 2124. The memory 2122 may store software and data through an appropriate internal and external device. The memory 2122 may include a random access memory (RAM), a read only memory (ROM), a hard disk, and a memory 2122 device connected to a dongle.

The memory 2122 may store at least an operating system (OS), a user application, and executable instructions. The memory 2122 may also store application data and array data structures.

The processor 2124 is a microprocessor or a suitable electronic processor and may be a controller, a microcontroller, or a state machine.

The processor 2124 may be implemented as a combination of computing devices, and the computing devices may be a digital signal processor, a microprocessor, or a suitable combination thereof.

In addition, the control device 2100 may monitor internal and external features of the vehicle 2000 with at least one sensor 2110 and detect a state.

The sensor 2110 may include at least one sensing module 2004, and the sensing module 2004 may be implemented at a specific location of the vehicle 2000 according to a sensing purpose. The sensing module may be located at a lower portion, a rear end, a front end, an upper end, or a side end of the vehicle 2000, and may also be located in an internal component or a tire of the vehicle.

Through this, the sensing module 2004 may sense driving-related information such as an engine 2006, a tire, a steering angle, a speed, and a weight of the vehicle as internal information of the vehicle. In addition, at least one sensing module 2004 may include an acceleration sensor 2110, a gyroscope, an image sensor 2110, a RADAR, an ultrasonic sensor, a LiDAR sensor, and the like, and may sense motion information of the vehicle 2000.

The sensing module 2004 may receive, as external information, specific data on an external environmental state such as state information of a road in which the vehicle 2000 is located, surrounding vehicle information, and weather, and sense a parameter of the vehicle according to the received data. The sensed information may be temporarily or long-term stored in the memory 2122 according to a purpose.

The sensor 2110 may integrate and collect information of the sensing modules 2004 for collecting information generated inside and outside the vehicle 2000.

The control apparatus 2100 may further include a wireless communication apparatus 2130.

The wireless communication device 2130 is configured to implement wireless communication between vehicles 2000. For example, the vehicle 2000 may communicate with a user's mobile phone, another wireless communication device 2130, another vehicle, a central device (traffic control device), a server, or the like. The wireless communication device 2130 may transmit and receive a wireless signal according to an access wireless protocol. The wireless communication protocol may be Wi-Fi, Bluetooth, Long-Term Evolution (LTE), Code Division Multiple Access (CDMA), Wideband Code Division Multiple Access (WCDMA), or Global Systems for Mobile Communications (GSM), and the communication protocol is not limited thereto.

In addition, the vehicle 2000 may also implement vehicle-to-vehicle communication through the wireless communication device 2130. That is, the wireless communication device 2130 may perform communication with other vehicles on the road through vehicle-to-vehicle (V2V) communication. The vehicle 2000 may transmit and receive information such as driving warnings and traffic information through the vehicle-to-vehicle communication, and may request information from other vehicles or receive a request. For example, the wireless communication device 2130 may perform V2V communication with a dedicated short-range communication (DSRC) device or a Cellular-V2V (C-V2V) device. In addition to vehicle-to-vehicle communication, vehicle-to-everything (V2X) communication between the vehicle and other objects (e.g., an electronic device carried by a pedestrian) may also be implemented through the wireless communication device 2130.

In addition, the control device 2100 may include a LIDAR device 2140. The LIDAR device 2140 may detect an object around the vehicle 2000 during operation by using data sensed through a LIDAR sensor. The LIDAR device 2140 may transmit the detected information to the controller 2120, and the controller 2120 may operate the vehicle 2000 according to the detection information. For example, when there is a vehicle traveling at a low speed in the detection information, the controller 2120 may instruct the vehicle to reduce speed through the engine 2006. Alternatively, the controller may instruct to reduce entry speed according to a curvature of a curve through which the vehicle enters.

The control device 2100 may further include a camera module 2150. The controller 2120 may extract object information from an external image captured by the camera module 2150 and cause the controller 2120 to process the information.

In addition, the control device 2100 may further include imaging devices for recognizing an external environment. In addition to the LIDAR 2140, a RADAR, a GPS device, an Odometry device, and other computer vision devices may be used, and these devices may be selected or operated simultaneously as necessary to enable more precise detection.

The vehicle 2000 may further include a user interface 2008 for a user's input to the above-described control device 2100. The user interface 2008 may allow the user to input information through appropriate interaction. For example, it may be implemented as a touch screen, a keypad, an operation button, or the like. The user interface 2008 may transmit an input or a command to the controller 2120, and the controller 2120 may perform a control operation of the vehicle in response to the input or the command.

The user interface 2008 may also allow a device external to the vehicle 2000 to communicate with the vehicle 2000 through the wireless communication device 2130. For example, the user interface 2008 may be interoperable with a mobile phone, a tablet, or other computer device.

Furthermore, although the vehicle 2000 is described as including the engine 2006, it is also possible to include other types of propulsion systems. For example, the vehicle may be operated with electric energy, and may be operated through hydrogen energy or a hybrid system combining them. Therefore, the controller 2120 may include a propulsion mechanism according to the propulsion system of the vehicle 2000, and provide a control signal to the components of each propulsion mechanism.

Hereinafter, a detailed configuration of the control device 2100 for detecting the field of view image 220 from the rear image 210 of the vehicle 2000 will be described in more detail with reference to FIG. 16.

The control device 2100 includes a processor 2124. The processor 2124 may be a general-purpose single- or multi-chip microprocessor, a dedicated microprocessor, a microcontroller, a programmable gate array, or the like. The processor may also be referred to as a central processing unit (CPU). In addition, the processor 2124 may also be used as a combination of a plurality of processors.

The control device 2100 also includes a memory 2122. The memory 2122 may be any electronic component capable of storing electronic information. In addition to a single memory, the memory 2122 may also include a combination of memories 2122.

According to various embodiments, data and instructions 2122a for detecting the field of view image 220 from the rear image 210 of the vehicle 2000 may be stored in the memory 2122. When the processor 2124 executes the instructions 2122a, all or some of the instructions 2122a and data 2122b necessary for performing the instructions may be loaded 2124a and 2124b onto the processor 2124.

The control device 2100 may include a transmitter 2130a, a receiver 2130b, or a transceiver 2130c for allowing transmission and reception of signals. One or more antennas 2132aand 2132b may be electrically connected to the transmitter 2130a, the receiver 2130b, or each transceiver 2130c and may additionally include antennas.

The control device 2100 may include a digital signal processor (DSP) 2170. The DSP 2170 may allow the vehicle to quickly process digital signals.

The control device 2100 may include a communication interface 2180. The communication interface 2180 may include one or more ports and/or communication modules for connecting other devices with the control device 2100. The communication interface 2180 may allow a user to interact with the control device 2100.

The various components of the control device 2100 may be connected together by one or more buses 2190, and the buses 2190 may include a power bus, a control signal bus, a status signal bus, a data bus, and the like. Under the control of the processor 2124, the components may communicate information with each other through the bus 2190 and perform desired functions.

The device described above may be implemented as hardware components, software components, and/or a combination of hardware components and software components. For example, the device and components described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and one or more software applications executed on the operating system. In addition, the processing device may access, store, manipulate, process, and generate data in response to execution of software. For ease of understanding, although the processing device is described as being used singly in some cases, those skilled in the art will understand that the processing device may include a plurality of processing elements and/or a plurality of types of processing elements. For example, the processing device may include a plurality of processors or one processor and one controller. In addition, other processing configurations are also possible, such as a parallel processor.

The software may include a computer program, code, instructions, or a combination of one or more thereof, and may configure the processing device to operate as desired or may instruct the processing device independently or collectively. The software and/or data may be embodied in any type of machine, component, physical device, computer storage medium, or device for interpretation by the processing device or for providing instructions or data to the processing device. The software may be distributed over networked computer systems and may be stored or executed in a distributed manner. The software and data may be stored on one or more computer-readable recording media.

The method according to various embodiments may be implemented in the form of program instructions that may be performed through various computer means and may be recorded on a computer-readable medium. In this case, the medium may continue to store a computer-executable program or may be temporarily stored for execution or download. In addition, the medium may be various recording means or storage means in the form of a single or a combination of several hardware, and is not limited to a medium directly connected to a computer system, and may be distributed on a network. Examples of the medium may include a magnetic medium such as a hard disk, a floppy disk, and a magnetic tape, an optical recording medium such as a CD-ROM and a DVD, a magneto-optical medium such as a floptical disk, and a medium configured to store program instructions including a ROM, a flash memory, and the like. In addition, examples of other media may include a recording medium or a storage medium managed by an app store that distributes an application, a site that supplies or distributes various software, a server, or the like.

Various embodiments of this document and terms used therein are not intended to limit the technology described in this document to particular embodiments, but are to be understood to encompass various modifications, equivalents, and/or alternatives of those embodiments. In connection with the description of the drawings, like reference numerals may be used for like elements. A singular expression may include a plural expression unless the context clearly indicates otherwise. In this document, expressions such as "A or B," "at least one of A and/or B," "A, B, or C," or "at least one of A, B, and/or C" may include all possible combinations of the items listed together. Expressions such as "first," "second," "first," or "second" may modify the corresponding elements regardless of order or importance, and are used only to distinguish one element from another and do not limit the corresponding elements. When an element (e.g., a first element) is referred to as being "(functionally or communicatively) connected" or "coupled" to another element (e.g., a second element), the element may be directly connected to the other element or may be connected through another element (e.g., a third element).

The term "module" used in this document includes a unit configured by hardware, software, or firmware, and may be used interchangeably with terms such as logic, a logic block, a component, or a circuit. A module may be an integrally configured component or a minimum unit or a part thereof that performs one or more functions. For example, a module may be configured as an application-specific integrated circuit (ASIC).

According to various embodiments, each component (e.g., module or program) of the described components may include a single entity or a plurality of entities. According to various embodiments, one or more of the corresponding components or operations described above may be omitted, or one or more other components or operations may be added. Alternatively or additionally, a plurality of components (e.g., modules or programs) may be integrated into a single component. In this case, the integrated component may perform one or more functions of each component of the plurality of components in the same or similar manner as performed by the corresponding component among the plurality of components prior to integration. According to various embodiments, operations performed by a module, program, or other component may be executed sequentially, in parallel, repeatedly, or heuristically, or one or more of the operations may be executed in a different order, omitted, or one or more other operations may be added.

What is claimed is:

1. A digital rear mirror system for a vehicle, comprising:
a camera device configured to capture a rear image of the vehicle; and
a digital rear mirror device configured to display a field of view image detected from the rear image.

2. The digital rear mirror system of claim 1,
wherein the digital rear mirror device has a display area of a predetermined resolution and is configured to display the field of view image in the display area.

3. The digital rear mirror system of claim 2,
wherein the camera device is configured to detect the field of view image from the rear image based on the resolution of the display area.

4. The digital rear mirror system of claim 3,
wherein the camera device is configured to detect, in the rear image, the field of view image from a position set based on a user input.

5. The digital rear mirror system of claim 4,
wherein the digital rear mirror device is configured to sense the user input, determine the position based on the user input, and transmit the position to the camera device to cause the camera device to set the position.

6. The digital rear mirror system of claim 4,
wherein the camera device is configured to receive the user input from the digital rear mirror device and set the position based on the user input.

7. The digital rear mirror system of claim 2,
wherein the digital rear mirror device is configured to detect the field of view image from the rear image based on the resolution of the display area.

8. The digital rear mirror system of claim 7,
wherein the digital rear mirror device is configured to detect, in the rear image, the field of view image from a position set based on a user input.

9. The digital rear mirror system of claim 8,
wherein the digital rear mirror device is configured to sense the user input and set the position based on the user input.

10. A digital rear mirror device of a vehicle, the digital rear mirror device comprising:
a display module having a display area;
an interface module communicatively connected to a camera device for capturing a rear image of the vehicle; and
a processor connected to the display module and the interface module and configured to display a field of view image detected from the rear image in the display area.

11. The digital rear mirror device of claim 10,
wherein the camera device detects the field of view image from the rear image based on the resolution of the display area, and
wherein the processor receives the field of view image from the camera device.

12. The digital rear mirror device of claim 11,
wherein the camera device detects the field of view image from a position set based on a user input in the rear image, and
wherein the processor is configured to sense the user input, determine the position based on the user input, and transmit the position to the camera device; or
is configured to sense the user input and transmit the user input to the camera device.

13. The digital rear mirror device of claim 10,
wherein the processor is configured to receive the rear image from the camera device and detect the field of view image from the rear image based on the resolution of the display area.

14. The digital rear mirror device of claim 13,
wherein the processor is configured to detect, in the rear image, the field of view image from a position set based on a user input.

15. A method of operating a digital rear mirror system of a vehicle, the method comprising:
capturing a rear image of the vehicle by a camera device; and
displaying, by a digital rear mirror device, a field of view image detected from the rear image.

16. The method of claim 15,
wherein the displaying of the field of view image comprises:
displaying, by the digital rear mirror device, the field of view image through a display area of a predetermined resolution; and
detecting, by the camera device, the field of view image from the rear image based on the resolution of the display area.

17. The method of claim 16,
wherein the detecting of the field of view image comprises:
detecting, by the camera device, the field of view image from a position set based on a user input in the rear image.

18. The method of claim 17,
wherein the digital rear mirror device senses the user input and either:
(i) determines the position based on the user input and transmits the position to the camera device; or
(ii) transmits the user input to the camera device,
and wherein the camera device sets the position based on the received position or the received user input.

19. The method of claim 15,
further comprising detecting, by the digital rear mirror device, the field of view image from the rear image based on the resolution of the display area, and
wherein the detecting of the field of view image comprises:
detecting, by the digital rear mirror device, the field of view image from a position set based on a user input in the rear image.

20. A camera device connected to a digital rear mirror device in a vehicle, the camera device comprising:
an interface module communicatively connected to the digital rear mirror device;
a camera module configured to capture a rear image of the vehicle; and
a processor connected to the interface module and the camera module, and configured to detect a field of view image from the rear image, and transmit the field of view image to a digital rear mirror device to cause the digital rear mirror device to display the field of view image.
